(19) United States
(12) Patent Application Publication
(10) Pub. No.: US 2024/0106873 A1
(43) Pub. Date: Mar. 28, 2024

(54) SHARED DIALOGS FOR INITIATING A COLLABORATIVE SESSION

(71) Applicant: Zoom Video Communications, Inc., San Jose, CA (US)

(72) Inventors: Bradley Dushman, West Hollywood, CA (US); Ross Douglas Mayfield, Palo Alto, CA (US)

(73) Assignee: Zoom Video Communications, Inc., San Jose, CA (US)

(21) Appl. No.: 17/951,263

(22) Filed: Sep. 23, 2022

(51) Int. Cl. H04L 65/401; H04L 65/403

(52) U.S. Cl. CPC H04L 65/4015; H04L 65/403

(57) ABSTRACT

Systems and methods for providing shared dialogs for initiating a collaborative session are provided. In an aspect, a system comprising a non-transitory computer-readable medium; a communications interface; and a processor communicatively coupled to the non-transitory computer-readable medium and the communications interface. The processor may be configured to execute processor-executable instructions stored in the non-transitory computer-readable medium to: receive, from a first client device, a request to initiate a collaborative session with a second client device; determine a status associated with a user of the second client device; determine, responsive to the status associated with the user of the second client device, identity information for the user; and transmit, to the second client device, access to the collaborative session.

### FIELD

The present application generally relates to shared dialogs, and more particularly relates to systems and methods for providing shared dialogs for initiating a collaborative session.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1, 2, and 3 show example systems for providing shared dialog during a collaborative session, according to an embodiment herein;

FIG. 4 illustrates a graphical participant interface for providing shared dialog during a virtual meeting, according to an embodiment herein;

FIG. 5 illustrates an example master panel for initiating a collaborative session outside of a virtual meeting environment, according to an embodiment herein;

FIG. 6 illustrates an example shared dialog prompt for initiating a collaborative session, according to an embodiment herein;

FIG. 7 illustrates an example shared dialog request prompt for initiating a collaborative session, according to an embodiment herein;

FIG. 8 depicts another exemplary method for providing shared dialog during a collaborative session, according to an embodiment herein; and

FIG. 9 shows an example computing device suitable for providing shared dialog during a collaborative session, according to this disclosure.

### DETAILED DESCRIPTION

Examples are described herein in the context of systems and methods for providing shared dialog during a collaborative session. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

As the popularity of virtual meetings to replace conventional, in-person meetings, continues to rise, so too does the prevalence of collaborative sessions. Collaborative sessions often involve sharing or simultaneously working within a document or application by two or more participants. The participants can be invited to review, edit, or comment on content within the collaborative session. Collaborative sessions allow participants to collaboratively work on the same content simultaneously, thereby producing a single product upon completion.

Collaborative sessions may take various forms, depending on the type of application hosting the collaborative session. For example, a collaborative session may include a document editing application that allows participants to review or edit content of a document. In another example, the collaborative session may be a video or audio application that allows participants to review or edit content of a video or audio recording or file. In still another example, a collaborative session may include a web-based application that allows participants to review or edit web-based content.

In some scenarios, a collaborative session can be initiated during a virtual meeting to facilitate or supplement a discussion. Presently, when a meeting participant seeks to initiate a collaborative session, only participants who are part of the virtual meeting may be sent a request to join the collaborative session. Moreover, if a participant joins the virtual meeting anonymously or using an account that is not registered with the video conference provider, the meeting participant may not be able to invite the participant to the collaborative session because there is no identity information available for the non-registered or anonymous participant.

Moreover, to join the collaborative session, the requested participant must have the application hosting the collaborative session already available on his or her computing device. If the requested participant does not have the application available on his or her computing device, the requested participant must leave the virtual meeting space, find the application hosting the collaborative session, and download or otherwise access the application before being able to attend the collaborative session. Currently, these steps to gain access to the collaborative session application can cause the requested participant to miss out on time or content of the virtual meeting as well as delay the requested participant from joining the collaborative session.

In some embodiments, a collaborative session may be initiated by participants outside the context of a virtual meeting. For example, a collaborative session may be initiated within a chat environment or channel. In such embodiments, to send participants a request to join the collaborative session, identity information for the participants must be available within the chat channel. If a requesting participant wants to invite a participant to the collaborative session, the requested participant must be part of the chat. Moreover, there are similar issues outside of the virtual meeting environment as within the virtual meeting environment in that any requested participant must have the application hosting the collaborative session available or spend time and resources gaining access to the application before being able to join the collaborative session.

To provide a streamlined process that allows requesting participants to join a collaborative session, regardless of their status (e.g., registered vs. nonregistered participant, anonymous attendance or non-anonymous attendance) or their availability to an application hosting the collaborative session, shared dialogs for a collaborative session are provided herein. Example shared dialogs discussed herein may function to share profile data between participants, similar to a social networking functionality, and in some cases, profile data with an application hosting a collaborative session. For example, if a requested participant is a contact of another participant, the identity information may be shared with the requesting participant such to share the collaborative session request.

Additionally, the example shared dialogs and the related methods of initiating a collaborative session provided herein can allow a participant to share access to an object/content within an application during a collaborative session. The participant may also provide a permission level for a requested participant to edit, comment, or view the content within the application. In some cases, the identity information of the requested participant may be used as a unique identifier within the application to allow the requested participant access in accordance with the set permission level.

If a requested participant does not have the application for the collaborative session available, the shared dialog may also provide quick access to download or gain access to the application within the current environment. For example, if the collaborative session is requested during a virtual meeting and the requested participant does not have the application for the collaborative session, the shared dialog can provide access to the application within the virtual meeting via a single selection by the requested participant. In this manner, the requested participant does not have to leave the virtual meeting to gain access to the application.

Moreover, the systems and methods provided herein provide improvements to the collaborative session process. More particularly to the initiation step of the collaborative session process. As discussed in greater detail below, the example shared dialogs provided herein can allow the sharing of information between applications, platforms, and systems to facilitate the initiation of a collaborative session. For example, via a single step a determination can be made of a user's identity information status and whether the user has access to the application hosting the collaborative session. Based on this determination, the user can either be joined to the collaborative session or receive a contact request, and the user can be provided with the option to gain access to the application hosting the collaborative session. By streamlining and sharing information between applications, systems, or platforms, the processing power or requirements for initiating a collaborative session may be reduced, thereby increasing the speed at which the collaborative session can be initiated.

This illustrative example is given to introduce the reader to the general subject matter discussed herein and the disclosure is not limited to this example. The following sections describe various additional non-limiting examples and examples of systems and methods for providing shared dialog for a collaborative session.

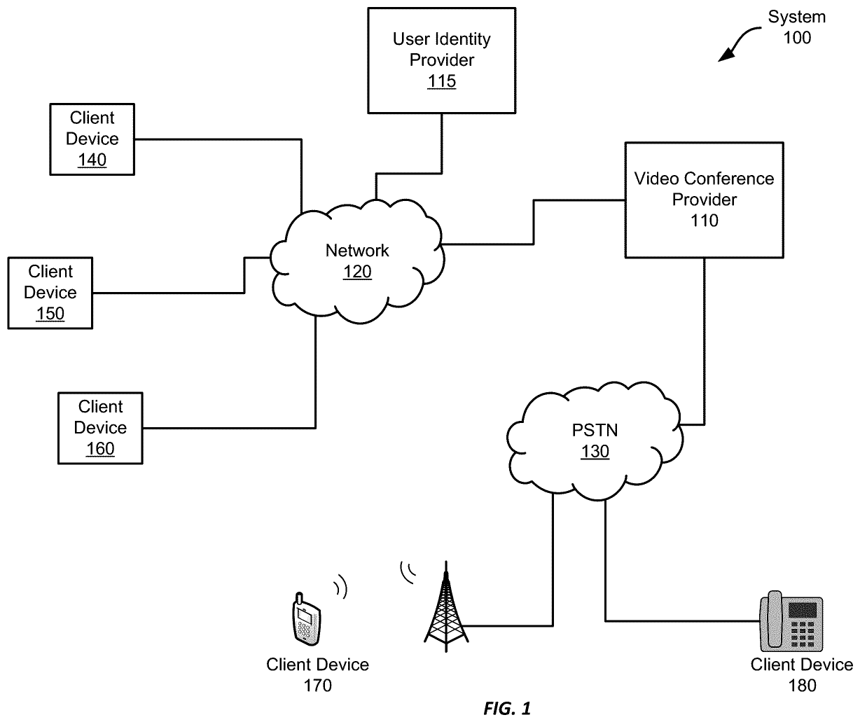

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the video conference provider 110 over a public network.

The system optionally also includes one or more participant identity providers, e.g., participant identity provider 115, which can provide participant identity services to participants of the client devices 140-160 and may authenticate participant identities of one or more participants to the video conference provider 110. In this example, the participant identity provider 115 is operated by a different entity than the video conference provider 110, though in some examples, they may be the same entity.

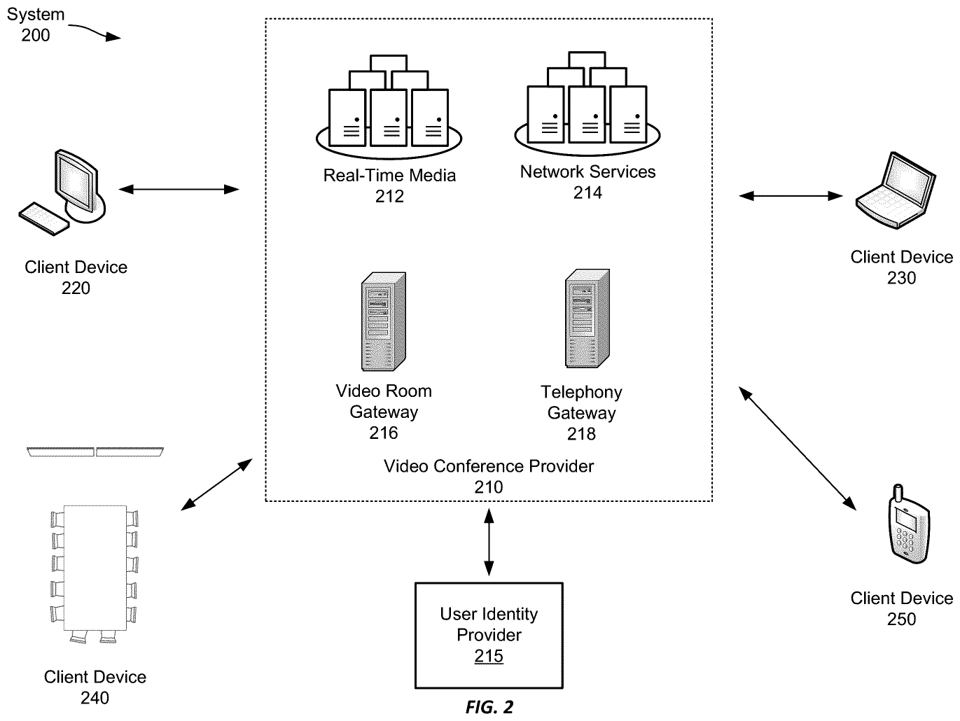

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage participant functionality in the meetings, enable text messaging during the meetings, create and manage breakout rooms from the virtual meeting, etc. FIG. 2, described below, provides a more detailed description of the architecture and functionality of the video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the video conference provider 110, a participant may contact the video conference provider 110 using a client device 140-180 and select an option to create a new meeting. Such an option may be provided in a webpage accessed by a client device 140-160 or client application executed by a client device 140-160. For telephony devices, the participant may be presented with an audio menu that they may navigate by pressing numeric buttons on their telephony device. To create the meeting, the video conference provider 110 may prompt the participant for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the participant may distribute the meeting information to one or more participants to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit participants to the meeting. Depending on the options set for the meeting, the participants may be admitted immediately upon providing the appropriate meeting identifier (and authentication information, as appropriate), even if the host has not yet arrived, or the participants may be presented with information indicating the that meeting has not yet started or the host may be required to specifically admit one or more of the participants.

During the meeting, the participants may employ their client devices 140-180 to capture audio or video information and stream that information to the video conference provider 110. They also receive audio or video information from the video conference provider 210, which is displayed by the respective client device 140 to enable the various participants to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The video conference provider 110 may also invalidate the meeting information, such as the meeting identifier or password/passcode. As discussed in detail below, in some embodiments, a first virtual meeting may terminate, thereby disconnecting only participants in that sidebar meeting. The virtual meeting may continue allowing participants therein to continue exchanging audio and video streams.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more participants to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a participant to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the participant to make and receive phone calls, e.g., using a headset and microphone. Such software may communicate with a PSTN gateway to route the call from a computer network to the PSTN. Thus, telephony devices encompass any devices that can making conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide participant identification information, meeting identifiers, meeting passwords or passcodes, etc. In examples that employ a participant identity provider 115, a client device, e.g., client devices 140-160, may operate in conjunction with a participant identity provider 115 to provide participant identification information or other participant information to the video conference provider 110.

A participant identity provider 115 may be any entity trusted by the video conference provider 110 that can help identify a participant to the video conference provider 110. For example, a trusted entity may be a server operated by a business or other organization and with whom the participant has established their identity, such as an employer or trusted third-party. The participant may sign into the participant identity provider 115, such as by providing a username and password, to access their identity at the participant identity provider 115. The identity, in this sense, is information established and maintained at the participant identity provider 115 that can be used to identify a particular participant, irrespective of the client device they may be using. An example of an identity may be an email account established at the participant identity provider 110 by the participant and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a participant's “identity” relates to a secure, verified set of information that is tied to a particular participant and should be accessible only by that participant. By accessing the identity, the associated participant may then verify themselves to other computing devices or services, such as the video conference provider 110.

When the participant accesses the video conference provider 110 using a client device, the video conference provider 110 communicates with the participant identity provider 115 using information provided by the participant to verify the participant's identity. For example, the participant may provide a username or cryptographic signature associated with a participant identity provider 115. The participant identity provider 115 then either confirms the participant's identity or denies the request. Based on this response, the video conference provider 110 either provides or denies access to its services, respectively.

For telephony devices, e.g., client devices 170-180, the participant may place a telephone call to the video conference provider 110 to access video conference services. After the call is answered, the participant may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide participant identification information to identify the telephony device or the participant to the video conference provider 110. Thus, the video conference provider 110 may provide more limited functionality to such telephony devices. For example, the participant may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that participants may choose to participate in meetings anonymously and decline to provide participant identification information to the video conference provider 110, even in cases where the participant has an authenticated identity and employs a client device capable of identifying the participant to the video conference provider 110. The video conference provider 110 may determine whether to allow such anonymous participants to use services provided by the video conference provider 110. Anonymous participants, regardless of the reason for anonymity, may be restricted as discussed above with respect to participants employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some participants from participating in a meeting.

By using the example system shown in FIG. 1, participants can create and participate in meetings using their respective client devices 140-180 via the video conference provider 110. Further, such a system enables participants to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more participant identity providers 215, which can authenticate various participants to the video conference provider 210 generally as described above with respect to FIG. 1.

In this example, the video conference provider 210 employs multiple different servers (or groups of servers) to provide different Examples of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the video conference provider 210 may provide certain functionality with respect to unencrypted multimedia streams at a participant's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage participant accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a participant, e.g., a username and password or single sign-on credentials, to gain authenticated access to the video conference provider 210. This process may involve the network services servers 214 contacting a participant identity provider 215 to verify the provided credentials. Once the participant's credentials have been accepted, the network services servers 214 may perform administrative functionality, like updating participant account information, if the participant has an identity with the video conference provider 210, or scheduling a new meeting, by interacting with the network services servers 214.

In some examples, participants may access the video conference provider 210 anonymously. When communicating anonymously, a client device 220-250 may communicate with one or more network services servers 214 but only provide information to create or join a meeting, depending on what features the video conference provider allows for anonymous participants. For example, an anonymous participant may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a participant wishes to schedule a meeting, the participant (anonymous or authenticated) may select an option to schedule a new meeting and may then select various meeting options, such as the date and time for the meeting, the duration for the meeting, a type of encryption to be used, one or more participants to invite, privacy controls (e.g., not allowing anonymous participants, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various participants.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent participants requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another participant as the new meeting host and assign host administrative privileges to that participant. Hosts may have administrative privileges to allow them to manage their meetings, such as by enabling or disabling screen sharing, muting or removing participants from the meeting, assigning or moving participants to the mainstage or a breakout room if present, recording meetings, etc. Such functionality may be managed by the network services server(s) 214.

For example, if a host wishes to remove a participant from a meeting, they may identify the participant and issue a command through a participant interface on their client device. The command may be sent to a network services server 214, which may then disconnect the identified participant from the corresponding real-time media server 212. If the host wishes to remove one or more participants from a second meeting, such a command may also be handled by a network services server 214, which may terminate the authorization of the one or more participants for joining the sidebar meeting. In some embodiments, the host may wish to join one or more participants in a second meeting. The command to do so may be handled by a network services server 214, which may provide authorization information to the one or more participants to join the sidebar meeting and then connect the one or more participants to the sidebar meeting similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a participant later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a participant uses a telephony device to connect to a meeting, they may dial a phone number corresponding to one of the video conference provider's telephony gateway servers 218. The telephony gateway server 218 will answer the call and generate audio messages requesting information from the participant, such as a meeting ID and passcode. The participant may enter such information using buttons on the telephony device, e.g., by sending dual-tone multi-frequency (“DTMF”) audio signals to the telephony gateway server 218. The telephony gateway server 218 determines the numbers or letters entered by the participant and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the participant of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

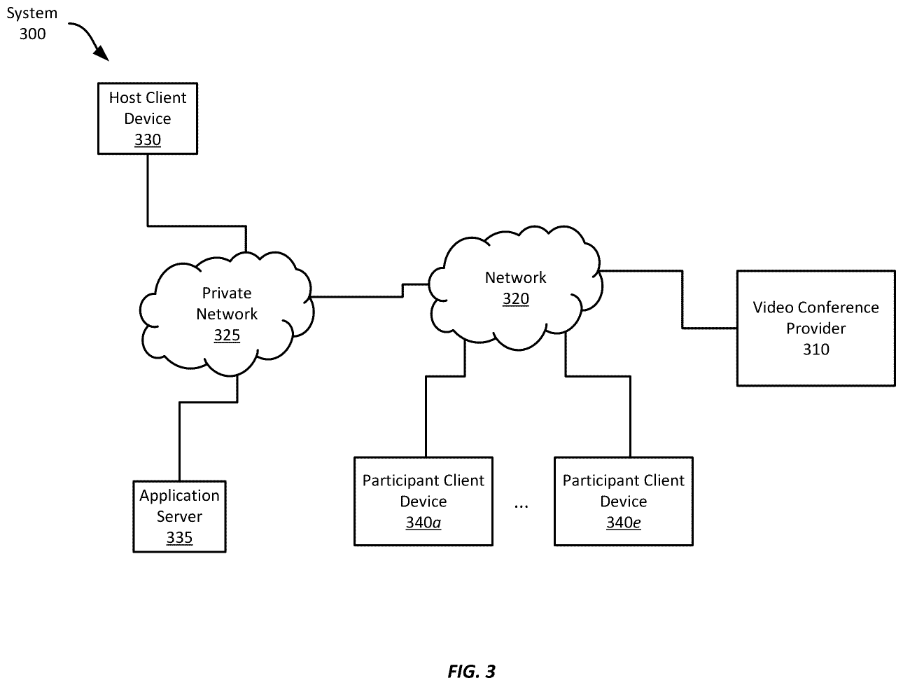

Referring now to FIG. 3, FIG. 3 shows an example system 300 for providing a request to initiate a collaborative session. In this example, a video conference provider 310 provides video conference services to multiple different client devices 330 and 340a-m, generally as described above with respect to FIGS. 1 and 2. In this example, the client devices 330 and 340a-m participate in a meeting hosted by the video conference provider 310. Client devices 340a-m connect to the video conference provider 310 over a public network 320, e.g., the internet; however, host client device 330 participates from within a private network 325, such as from their office at work. In addition to the host client device 330, an application server 335 is connected to the private network and makes various business applications available to the host client device 330. In different examples, these business applications may vary; however, in this example, the application server 335 provides applications to access business databases and files. To access these various resources, the host client device 330 has different client applications installed on it and may also have web applications accessible via a web browser, which may be stored as bookmarks in the web browser.

To start a meeting, the host client device 330 connects to the video conference provider 310 and begins a virtual meeting at the video conference provider 310, such as by beginning a scheduled meeting, generally as described above with respect to FIGS. 1 and 2. The video conference provider 310 may create and manage the meeting as discussed above.

Once the virtual meeting is started, participants may be able to interact with other participants and see their respective names, such as in close proximity to other participants' video streams or in a list of participants visible in a graphical user interface (“GUI”). In some embodiments, the participants may only be able to see information, e.g., names or video feeds, from the host(s) of the webinar or certain select participants that will be engaged in discussions during the virtual meeting, such as panelists in a panel discussion. Still other limits may be imposed on the various participants, such as their ability to react to occurrences during the meeting, e.g., participants may be allowed to interact with their GUI to raise their hand to ask a question, but may not be allowed to provide any other feedback.

During the virtual meeting, the participant associated with the client device 340a may wish to initiate a collaborative session with the other meeting participants. To initiate the collaborative session, the participant may submit a request to the video conference provider 310 to initiate the collaborative session. In some embodiments, the collaborative session may be locally or remotely hosted by the video conference provider 310, the network 320, or the private network 325. In some embodiments, the collaborative session may be hosted or provided by an application. The application may be a separate application from the application hosting the virtual meeting. For example, the collaborative session may be a collaborative document hosted by a document editing application that allows more than one participant to access and make edits to the collaborative document. The one or more participants of the collaborative session may be the same as any one of the participants associated with the client devices 340a-m.

Upon receipt of the request to initiate the collaborative session, the video conference provider 310 may transmit the request to the identified participants in the request (hereinafter the “requested participants”). For example, if the request is for the client device 340e to join the collaborative session, the video conference provider 310 may transmit the request to the client device 340e. It should be understood that while the following discussion only includes the client device 340e as the requested participant for the collaborative session for ease of discussion, there could be any number of requested participants.

In some embodiments, prior to transmitting the request to the client device 340e, the video conference provider 310 may determine identity information of a user of the client device 340e. Identity information of the user may include personally identifiable information for the user. For example, the identity information may include information provided by an identity provider, such as, the identity provider 115. In some embodiments, identity information may include an email address, a social media handle, or a phone number for the client device 340e, while in other embodiments, the identity information may include an employer or a location of the user.

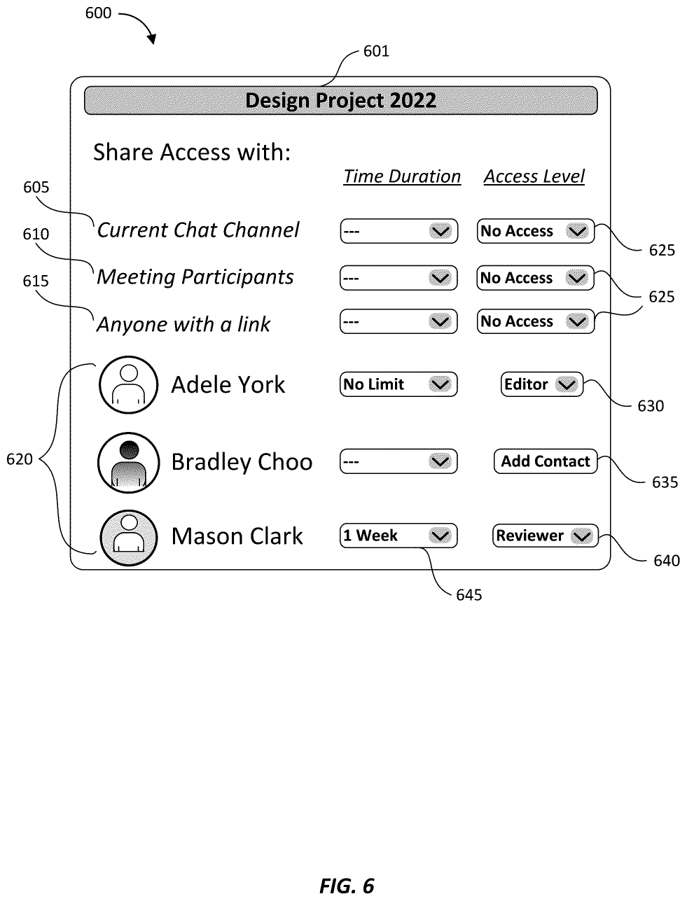

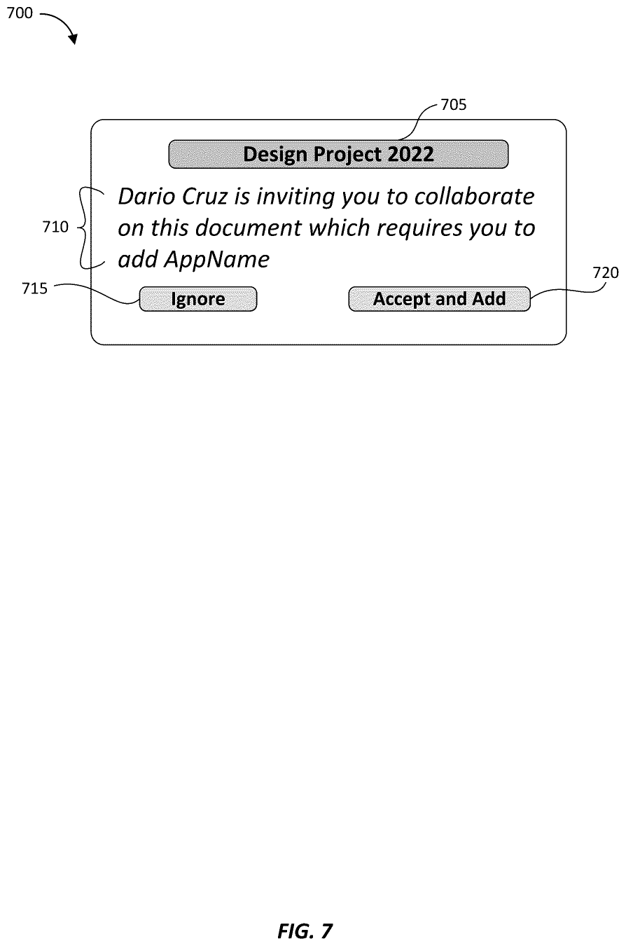

To determine the identity information of the user, the video conference provider 310 may determine a status of the user or the client device 340e. A status of the user may include whether the user is registered with the video conference provider 310, has a profile associated with the video conference provider 310, is attending the virtual meeting anonymously, or has an identity provided by a third party that includes contact information, such as information provided by the identity provider 115. If the user has a profile or is registered with the video conference provider 310, the video conference provider 310 may determine the identity information for the user via his or her status. In the alternative, if the user is not registered or does not have a profile, or is attending anonymously, the video conference provider 310 may transmit a request to the client device 340e for the user's identity information. Determining and receiving identity information for a user is discussed in greater detail below with respect to FIGS. 6 and 7.

In addition to determining the status of the user of the client device 340e, the video conference provider 310 may determine whether the client device 340e has access to an application hosting the collaborative session. As noted above, a collaborative session may be hosted by an application and to join the collaborative session a requested participant must have access to the application. The video conference provider 310 may determine the user of the client device 340e has access to the application using the identity information of the user. For example, the video conference provider 310 may determine a profile associated with the user for the application. In other embodiments, the video conference provider 310 may communicate with the client device 340e to determine that the client device 340e has access to the application.

If the video conference provider 310 determines that the client device 340e does not have access to the application, the video conference provider 310 may transmit a prompt to the client device 340e to download or otherwise gain access to the application. The determination of the application availability and access, along with the prompt to download the application is discussed in greater detail below with respect to FIGS. 6 and 7.

After the video conference provider 310 transmits the request to the client device 340e and the client device 340e accepts the request to join the collaborative session, the client device 340e may access the collaborative session. In some embodiments, when the client device 340e joins the collaborative session, a notification may be provided to the other participants to indicate the presence of the client device 340e.

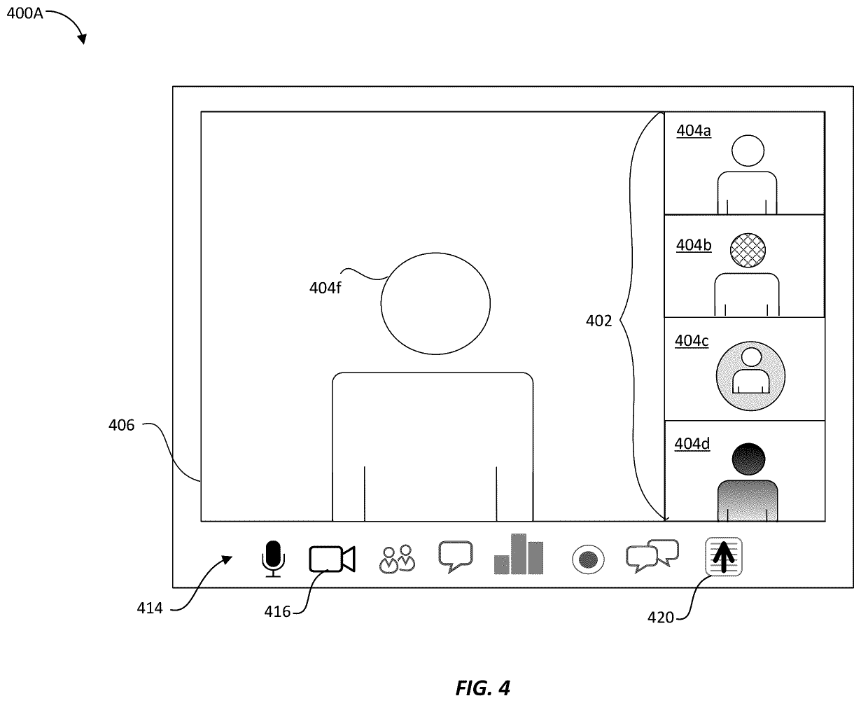

Referring now to FIG. 4, FIG. 4 illustrates a GUI 400 for initiating a collaborative session during a virtual meeting, according to an embodiment. The GUI 400 may be presented to a participant or a host during a virtual meeting, such as the virtual meeting 350. The following figures and related components, such as GUI 400 of FIG. 4, will be described with respect to systems shown in FIG. 3, however, any suitable system according to this disclosure may be employed, such as those described in FIGS. 1 and 2.

In some embodiments, a GUI 400 is viewable to a participant of the video conference on the participant's device, for example the GUI 400 may be viewable to participant A on the client device 340a. Presentation of the GUI 400 on the participant's device may be in response to the initiation of the video conference.

The GUI 400 may include a roster 402 of the participants 404a-e in the video conference. The roster 402 may include a video stream of some or all of the participants 404a-e. In other embodiments, the roster 402 may include a picture, image, representation, avatar or a listing of some or all of the participants 404a-e who have joined the virtual meeting. When a participant joins the video conference, the joining participant is added to the roster 402.

Once the virtual meeting is initiated, video and audio streams may be exchanged between the participants 404a-e. Display 406 may display the video stream of a currently speaking participant 404e. The audio stream from participant 404e may also be transmitted along with the display 406. In some embodiments, more than one participant may be speaking, and in such cases, display 406 may include two or more windows providing the video streams from the speaking participants.

At some time after the virtual meeting is initiated, one or more of the participants 404a-e may wish to initiate a collaborative session with the other participants in the virtual meeting. To initiate a collaborative session within the virtual meeting, a participant, such as the participant 404a may select a share document option. For example, to initiate the collaborative session, participant 404a may select a collaborative session selection 420 on a dashboard 414. The dashboard 414 may contain one or more action selections. For example, dashboard 414 may include the collaborative session selection 420 and a recording selection 416 that allows a participant to record the streams of audio and video during the virtual meeting. Upon selection of the collaborative session selection 420, the participant 404a may be prompted to input or select an application for the collaborative session. For example, the collaborative session may be hosted by a document editing application, a whiteboard application, a web-based application, and the like.

In an example embodiment, the participant 404a may select a document to share during a collaborative session. During the collaborative session, the participant 404a and the other participants of the collaborative session may review and edit the shared document. For example, if the shared document is shared with the other participants 404b-e of the virtual meeting during the collaborative session, then the participant 404a may allow the other participants 404b-e to edit or make changes to the document during the collaborative session. As will be discussed in greater detail below with respect to FIGS. 6 and 7, upon initiated a request for a collaborative session, the participant 404a may select what participants to invite to the collaborative session and assign an involvement role or permission level for each of the collaborative session participants.

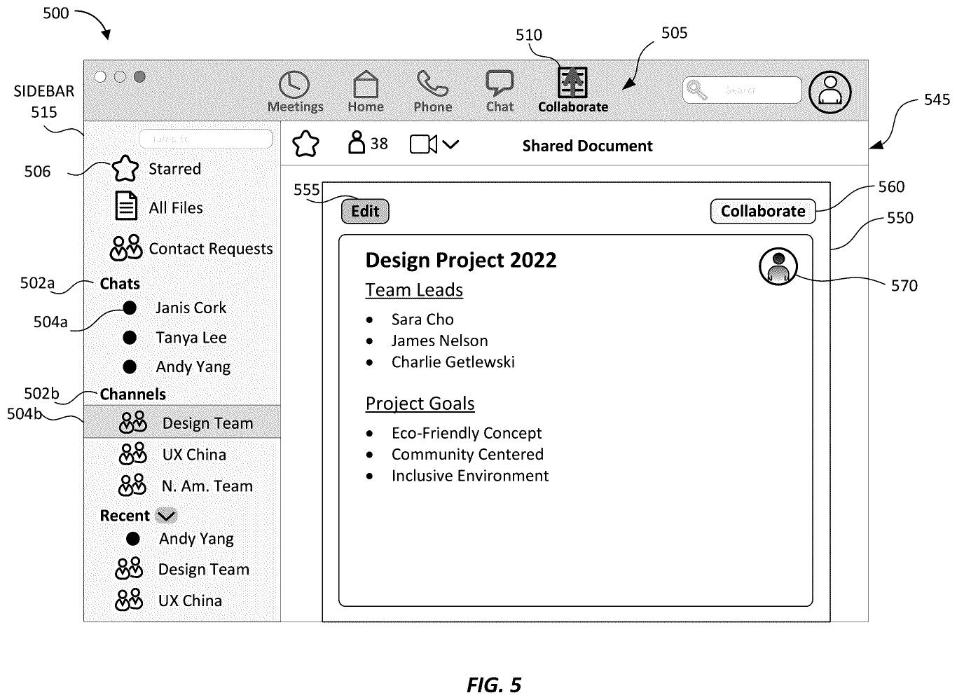

As noted above, in some embodiments, a participant may initiate a collaborative session outside of a virtual meeting environment. For example, the participant may initiate a collaborative session through a master panel hosted by a video conference provider, such as the video conference provider 310, or by a third party. Referring now to FIG. 5, an example master panel for initiating a collaborative session outside of a virtual meeting environment is provided. The master panel 500 may be displayed on a client device. The master panel 500 may be generated by an application run by one or more processors stored on the client device. The client device may be a personal computer such as a desktop or laptop, a mobile device, or other computing device having at least a processor, non-transitory memory, a participant input system, and communication interface, providing network connectivity.

The master panel 500 may include a general dashboard 505, a chat control dashboard 545, a sidebar 515, and a collaborative session window 550. The general dashboard 505 may include one or more buttons or links that switch functionalities or views of the master panel 500. For example, FIG. 5 shows a collaborative session view, perhaps in response to a participant command selecting a collaborative session button 510 in the general dashboard 505. In this view, the collaborative session window 550 and other components illustrated in FIG. 5 may be displayed on the client device. In other examples, a participant may select a contacts button. In response to the contacts button being selected, the collaborative session window 550 may be replaced by a display of a contacts window including a list of participant contacts associated with the participant of the client device. The sidebar 515 may be displayed alongside the contacts window. Other configurations are also possible. Various buttons on the control dashboard 545 may correspond to various displays of windows being displayed on the client device. Any number of components shown in FIG. 5 may be displayed on the client device with any of the various windows. Similarly, any of the components may cease to be displayed in accordance with any of the windows.

The sidebar 515 may include one or more chat channel headings. A chat channel heading 502a may include one or more chat channels such as the chat channel 504a. In some examples, the chat channel 504a may include a private chat, where the chat is between the participant associated with the client device and another participant. Messages sent and received via the chat channel 504a may only be accessed by the participants in the chat channel 504a. Thus, the client devices associated with the participant and the client device associated with the other participant may securely communicate with each other.

A chat channel heading 502b may include a chat channel 504b. The chat channel 504b may by a group chat, where two or more participants have access to send and receive messages within the chat channel. In some examples, the chat channel 504b may only be accessed by participants who have permission to enter the chat channel. A host of the chat channel 504b or the video chat and video conference provider may grant access to the chat channel 504b. Although only the chat channel headings 502a-b are shown, other chat channel headings are possible. For example, some examples may include a chat channel heading that displays, on the client device, only those channels that the participant associated with the client device is a member of that have been recently accessed. “Recently accessed” may be determined by the client device to be a fixed number of most recent channels accessed by the participant, or may be only those channels access within a certain time, calculated from the current time.

In some embodiments, a collaborative session may be associated with a chat channel. For example, the chat channel 504b may have an associated collaborative session, such as a collaborative or shared document. In such an example, the collaborative document associated with the chat channel 504b may be accessible and editable by only the participants of the chat channel 504b. When a collaborative document is associated with the chat channel 504b, the collaborative document may be accessed, and thereby edited, through the chat channel 504b. for example, a participant of the chat channel 504b may enter the chat channel 504b and be able to access the collaborative document within the chat channel 504b. In other embodiments, the participants of the chat channel 504b may invite other participants to a collaborative session associated with the chat channel.

In some embodiments, the sidebar 515 may also include one or more combinatory headings, such as starred combinatory heading 506. A combinatory heading may aggregate one or more messages from one or more chat channels, according to one or more predetermined criteria. The combinatory headings may include a link that, in response to a participant command, cause the client device to display messages in the collaborative session window 550. The messages may be gathered from one or more chat channels, such as the chat channel 504a-b, and displayed based on a predetermined criteria. In FIG. 5, for example, the starred combinatory heading 506 may gather only those messages that have been marked by a participant of the client device. The marked messages may be stored at the client device, or may be stored at the chat and video conference provider. The link may cause the one or more processors included on the client device to determine which messages are marked messages and cause them to be displayed in the master panel 500. In some examples, the link may cause the client device to send a signal to the chat and video conference provider. The chat and video conference provider may then determine which messages are marked messages and send information to the client device to generate a display of the marked messages in the master panel 500.

Other combinatory headings (and associated links and functionality) are also considered. Other examples may include a recently edit document heading, an all files heading, a contact request heading, and others. As with the starred combinatory heading 506, an associated link may cause the client device or the chat and video conference provider to determine which messages (if any) meet predetermined criteria associated with the combinatory heading and subsequently display those messages on the client device.

The control dashboard 545 may display one or more control buttons or information regarding the collaborative session currently being displayed on the client device. The control buttons may include links that mark a collaborative session (e.g., to mark it such that it is determined to be a marked message via the starred combinatory heading 506), begin a video conference, request to add participants to the collaborative session (e.g., via a collaborate button 560), or other tasks. The control dashboard 545 may also include a title of the collaborative session currently being displayed on the client device or a number of participants with access to the chat channel or collaborative session. One of ordinary skill in the art would recognize many different possibilities and configurations.

Upon selection of the collaborative session selection 510, a collaborative session window 550 may be displayed. The collaborative session window 550 may be a collaborative document that is shared with two or more participants. The two or more participants may have authorization to access, review, edit, or comment on the collaborative session window 550. The collaborative session window 550 may be stored on a local network or on a server hosted by the video conference provider or third party. By being stored remotely, the collaborative session window 550 may be accessed by more than one participant and any edits made by a participant may be saved to the collaborative session window 550.

When a participant accesses the collaborative session window 550, a presence indicator 570 of the participant within the document may be provided. For example, as illustrated, an image, avatar, or logo of the participant may be provided within the collaborative session window 550 to indicate the participant's presence. In other embodiments, a listing of participants who have joined the collaborative session may be provided, while in other embodiments, a chime or audible indication may be used to indicate the participant's presence.

When a participant requests to initiate a collaborative session, for example by selecting the collaborate button 560, the collaborative session button 510, or the collaborative session selection 420, the participant may be prompted to select participants to join the collaborative session and, in some embodiments, assign a permission level for each participant.

Turning now to FIG. 6, an example shared dialog prompt 600 for initiating a collaborative session is provided, according to an embodiment. The shared dialog prompt 600 may be provided to participant requesting the collaborative session (hereinafter the “requesting participant”). The shared dialog prompt 600 may include an identification 601 of content being shared during the collaborative session. For example, the identification 601 as illustrated indicates that the Design Project 2022 is the content of the collaborative session. In some embodiments, the identification 601 may also indicate the application hosting the collaborative session. For example, the Design Project 2022 may be a document that is hosted by a document editing application.

The shared dialog prompt 600 may include various options for participants to request to join the collaborative session. For example, the shared dialog prompt 600 may include an option 605 to share access with a current chat channel or participants of a current chat channel, an option 610 to share access to the collaborative session with all meeting participants, an option 615 to share access to the collaborative session with anyone with a link, or participant option 620 to share access to the collaborative session with individual participants. Based on the options selected, the request to join the collaborative session may be transmitted to the respective requested participant. For example, as illustrated, permissions or access selections 625 may indicate that anyone with a link and meeting participants who do not receive an individual participant request may not access the collaborative session. In some embodiments, this may mean that anyone with a link or meeting participants who do not receive an individual participant request may not receive a request to join the collaborative session at all.

The permissions level may also set an interaction level for participants who join the collaborative session. The permission level may include the interaction level of a participant with the content shared within the collaborative session or the permissions level may include the interaction level of the participant with the collaborative session itself. For example, for the interaction level of a participant with the content of the collaborative session may set the bounds or restrictions of how the participant can interact with the content. For example, the permission level may include the ability of the participant to review the content, edit the content, or comment on the content. As illustrated by FIG. 6, the participant Adele York may have a permission level 630 set to editor. This may allow Adele York to edit the content of the collaborative session. In contrast, the participant Mason Clark may have a permission level 635 set to reviewer. This may allow Mason Clark to view the content the collaborative session, however, Mason Clark cannot edit or comment on the content.

As noted above, in some embodiments, the permission level may involve the participant's interaction with the collaborative session itself. For example, these types of permission levels may include the participant's ability to invite other participants to join the collaborative session or the participant's ability to share access for the collaborative session. Depending on the type of collaborative session, the permission level may also include the ability of the participant to assign host roles or permission levels of other participants within the collaborative session.

In some embodiments, the permission level may have a time duration 645 for which the requested participant can join the collaborative session. For example, if the collaborative session involves a recording or an audio/video file, the permission level may allow the requested participant to join the collaborative session during a set time period (e.g., until a certain date or between two specified dates or times). In some embodiments, the time duration 645 may be for an interaction level of the requested participant with the content of the collaborative session. For example, the permission level may allow the requested participant to edit the content (e.g., the recording) during a set time duration 645. After that time duration 645 is over, the requested participant may no longer be able to edit the content of the collaborative session. While in some embodiments, when the time duration 645 is over, the requested participant may still be able to view the content or interact with the contact at some level (e.g., comment on the content), in other embodiments, the requested participant may no longer be able to access the content of the collaborative session or join the collaborative session at all.

In some embodiments, a requested participant may not be a contact of the requesting participant. In other words, the identity information for the requested participant may not be readily available. For example, the requested participant may not have a profile with the video conference provider or hosting third party, or the requested participant may be outside the company's network. This example is illustrated by the participant Bradley Choo. As illustrated by FIG. 6, the shared dialog prompt 600 may provide the option 640 to add Bradley Choo as a contact. In such examples, if the requesting participant desires to invite Bradley Choo to the collaborative session, the requesting participant may select the option 640 to add Bradley Choo as a contact. In such cases, responsive to the selection of option 640, a prompt may be provided to Bradley Choo to notify him of the request to add him as a contact.

As noted above, to join the collaborative session, a requested participant must have access to the application hosting the collaborative session. If the requested participant is a contact of the requesting participant and has access to the application, then the requested participant can join the collaborative session immediately upon receiving the request to join the collaborative session. If the requested participant is a contact of the requesting participant but does not have the application, then the requested participant may have to gain access to the application prior to having the ability to join the collaborative session. Historically, to gain access, the requested participant may have had to exit the current environment (e.g., the virtual meeting or the chat channel) and find the application for downloading. To limit the interruption to the requested participant in the current environment, the shared dialog process described herein may automatically find and provide an option to automatically gain access to the application to the requested participant.

Turning now to FIG. 7, an example shared dialog request prompt 700 (“request prompt 700”) for initiating a collaborative session is provided, according to an embodiment. For example, continuing the example from above, the participant Bradley Choo may receive the request prompt 700 along with the request to join the collaborative session. The request prompt 700 may provide a content indication 705 to inform Bradley Choo of the subject matter of the request. Additionally, the prompt 700 may provide text 710 that gives context to the request prompt 700. For example, as illustrated, the text 710 provides the name of the requesting participant and describes the content of the collaborative session. The text 710 also explains that the application AppName is required to access the collaborative session.

The request prompt 700 may include an option 715 to ignore the request and an option 720 to accept and add the application AppName. If Bradley Choo selects the option 715 to ignore the request, then the application AppName may not be added to a client device associated with Bradley Choo and Bradley Choo may not have access to the collaborative session. In some embodiments, the requesting participant may receive a notification that Bradley Choo has declined the request to add the application AppName.

If Bradley Choo selects the option 720 to accept and add the application AppName, then the application AppName may be automatically added to a client device associated with Bradley Choo. For example, the application AppName may be automatically downloaded onto the client device. Responsive to adding the application AppName, Bradley Choo may be joined into the collaborative session.

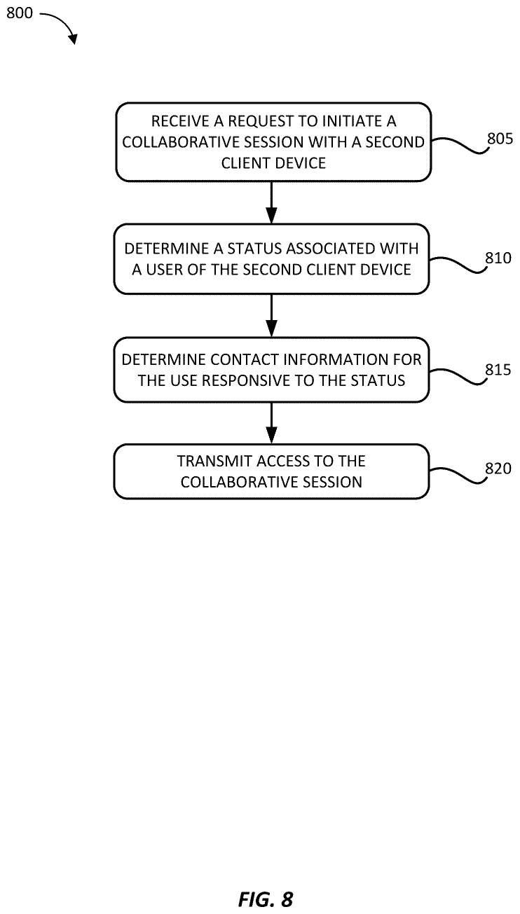

Referring now to FIG. 8, a flowchart of an example method 800 for providing shared dialog during a collaborative session is provided. For example, the method 800 may provide an example embodiment for initiating a collaborative session. The description of the method 800 in FIG. 8 will be made with reference to FIGS. 3-7, however any suitable system according to this disclosure may be used, such as the example systems 100 and 200, shown in FIGS. 1 and 2.

Method 800 may include step 805. At step 805, the method 800 may include receiving a request to initiate a collaborative session with a second client device. For example, a first client device, such as client device 340a, may transmit a request to a video conference provider, such as the video conference provider 310. The video conference provider 310 may receive the request to initiate the collaborative session with the second client device 340e and transmit the request to the second client device 340e. In some embodiments, the collaborative session may be the same or similar to the collaborative session window 550.

In some embodiments, the request may be received during a virtual meeting. In such embodiments, the method may further include establishing a virtual meeting having a plurality of participants. The plurality of participants may include the first client device and the second client device. If the request to initiate the collaborative session is received during a virtual meeting, the method may further include sharing the collaborative session with the plurality of participants during the virtual meeting. In some cases, the request to initiate the collaborative session during the virtual meeting may include a request to share collaborative content during the virtual meeting.

At step 810, the method 800 may include determining a status associated with a user of the second client device. For example, the video conference provider 310 may determine a status associated with the client device 340e. That is, the video conference provider 310 may determine whether the client device 340e has a profile associated with the video conference provider 310.

In some embodiments, the step 810 of the method 800 may also include determining that the second client device does not have access to an application associated with the collaborative session. For example, a determination may be made that the second client device does not have access to the application hosting the collaborative session. In such cases, the method may further include transmitting, to the second client device, a prompt to access the application to the second client device. The method 800 may further include receiving, from the second client device, a notification that the second client device accepted the prompt to access the application, and transmitting, responsive to the notification, access to the collaborative session.

At step 815, the method 800 may include determining, responsive to the status associated with the user of the second client device, identity information for the user. For example, in some embodiments, based on the profile associated with the user, the video conference provider 310 may determine identity information for the user of the client device 340e. In some embodiments, if at step 815 a determination is made that there is not a profile associated with the user, then method may further include transmitting, to the second client device, a contact request for the second client device. In such embodiments, the method may further include receiving, from the second client device, the identity information for the user responsive to the contact request. Then based on the identity information, the method may include transmitting to the second client device access to the collaborative session.

At step 820, the method 800 may include transmitting, to the second client device, access to the collaborative session. For example, the video conference provider 310 may transmit to the client device 340e access to the collaborative session. In some embodiments, once the second client device joins the collaborative session, the method may include receiving, from the second client device, a notification that the second client device accessed the application. In such embodiments, the method may further include providing in the collaborative session a notification that the second client device has joined the collaborative session.

In some embodiments, the method 800 may include determining, by the video conference provider, a permission level associated with the second client device for the collaborative session. In such embodiments, the method 800 may further include granting, by the video conference provider, the second client device access to the collaborative session based on the permission level.

In still other embodiments, the method 800 may include establishing, by the video conference provider, a chat channel including two or more participants. The two or more participants may include first client device and the second client device. In such embodiments, receiving, from the first client device, the request to access the collaborative session may further include sharing collaborative content within the chat channel.

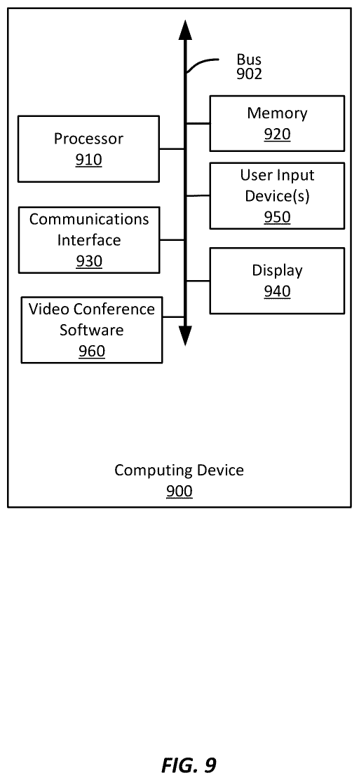

Referring now to FIG. 9, FIG. 9 shows an example computing device 900 suitable for use in example systems or methods for providing shared dialog to initiate a collaborative session. The example computing device 900 includes a processor 910 which is in communication with the memory 920 and other components of the computing device 900 using one or more communications buses 902. The processor 910 is configured to execute processor-executable instructions stored in the memory 920 to perform one or more methods for providing shared dialog to initiate a collaborative session, such as part or all of the example method 800, described above with respect to FIG. 8. The computing device, in this example, also includes one or more participant input devices 950, such as a keyboard, mouse, touchscreen, video input device (e.g., one or more cameras), microphone, etc., to accept participant input. The computing device 900 also includes a display 940 to provide visual output to a participant.

The computing device 900 also includes a communications interface 930. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), Participant Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a system comprising: a non-transitory computer-readable medium; a communications interface; and a processor communicatively coupled to the non-transitory computer-readable medium and the communications interface, the processor configured to execute processor-executable instructions stored in the non-transitory computer-readable medium to: receive, from a first client device, a request to initiate a collaborative session with a second client device; determine a status associated with a user of the second client device; determine, responsive to the status associated with the user of the second client device, identity information for the user; and transmit, to the second client device, access to the collaborative session.

Example 2 is the system of any previous or subsequent Example, wherein the instructions to determine the status associated with the user of the second client device further cause the processor to execute further processor-executable instructions stored in the non-transitory computer-readable medium to: determine a profile associated with the user; and determine, based on the profile, the identity information for the user.

Example 3 is the system of any previous or subsequent Example, wherein the instructions to determine the status associated with the user of the second client device further cause the processor to execute further processor-executable instructions stored in the non-transitory computer-readable medium to determine that the second client device has access to an application associated with the collaborative session; and the instructions cause the processor to execute further processor-executable instructions stored in the non-transitory computer-readable medium to transmit, to the second client device, access to the collaborative session.

Example 4 is the system of any previous or subsequent Example, wherein the instructions to determine the status associated with the user of the second client device further cause the processor to execute further processor-executable instructions stored in the non-transitory computer-readable medium to: determine that there is not a profile associated with the user; and transmit, to the second client device, a contact request for the second client device.

Example 5 is the system of any previous or subsequent Example, wherein the processor is configured to execute further processor-executable instructions stored in the non-transitory computer-readable medium to: receive, from the second client device, the identity information for the user responsive to the contact request; and transmit, to the second client device based on the identity information, access to the collaborative session.

Example 6 is the system of any previous or subsequent Example, wherein: the processor is configured to execute further processor-executable instructions stored in the non-transitory computer-readable medium to establish a virtual meeting having a plurality of participants, wherein the plurality of participants comprises the first client device and the second client device; and the instructions to receive, from the first client device, the request to initiate the collaborative session with the second client device cause the processor to execute further processor-executable instructions stored in the non-transitory computer-readable medium to: receive, from the first client device, a request to share collaborative content with the plurality of participants during the virtual meeting; and share the collaborative content with the plurality of participants during the virtual meeting.

Example 7 is a method comprising: receiving, from a first client device, a request to initiate a collaborative session with a second client device; determining, by a video conference provider, a status associated with a user of the second client device; determining, by the video conference provider, identity information for the user responsive to the status associated with the user of the second client device; and transmitting, by the video conference provider, access to the collaborative session to the second client device.

Example 8 is the method of any previous or subsequent Example, wherein determining the status associated with the user of the second client device further comprises: determining, by the video conference provider, a profile associated with the user; determining, based on the profile, the identity information for the user; determining, by the video conference provider, that the second client device has access to an application associated with the collaborative session; and transmitting, by the video conference provider, access to the collaborative session.

Example 9 is the method of any previous or subsequent Example, wherein determining the status associated with the user of the second client device comprises: determining, by the video conference provider, a lack of a profile associated with the user; and transmitting, by the video conference provider, a contact request based on the lack of the profile associated with the user.

Example 10 is the method of any previous or subsequent Example, wherein determining the status associated with the user of the second client device further comprises determining, by the video conference provider, that the second client device does not have access to an application associated with the collaborative session; and the method comprises: transmitting, to the second client device, a prompt to access the application to the second client device.

Example 11 is the method of any previous or subsequent Example, wherein the method further comprises: receiving, from the second client device, a notification that the second client device accepted the prompt to access the application; and transmitting, responsive to the notification, access to the collaborative session.

Example 12 is the method of any previous or subsequent Example, wherein the method further comprises: determining, by the video conference provider, a permission level associated with the second client device for the collaborative session; and granting, by the video conference provide, the second client device access to the collaborative session based on the permission level.

Example 13 is the method of any previous or subsequent Example, the method further comprising: establishing, by a video conference provider, a chat channel comprising two or more participants, wherein the two or more participants comprise the first client device and the second client device; and wherein receiving, from the first client device, the request to access the collaborative session further comprises sharing collaborative content within the chat channel.

Example 14 is the method of any previous or subsequent Example, wherein the collaborative session is hosted by an application, and wherein the method further comprises: determining, by the video conference provider, that the second client device has accessed the collaborative session via the application; and providing a notification in the application that the second client device has accessed the collaborative session.

Example 15 is a non-transitory computer-readable medium comprising processor-executable instructions configured to cause one or more processors to: receive, from a first client device, a request to initiate a collaborative session with a second client device; determine a status associated with a user of the second client device; determine, responsive to the status associated with the user of the second client device, identity information for the user; and transmit, to the second client device, access to the collaborative session.

Example 16 is the non-transitory computer-readable medium of any previous or subsequent Example, wherein the processor-executable instructions to determine the status of the second client device further cause the one or more processors to: determine whether there is a profile associated with the user; and determine whether the second client device has access to an application associated with the collaborative session.

Example 17 is the non-transitory computer-readable medium of any previous or subsequent Example, wherein the processor-executable instructions to determine whether there is the profile associated with the user further cause the one or more processors to: determine the profile associated with the user; and determine, based on the profile associated with the user, the identity information for the user.

Example 18 is the non-transitory computer-readable medium of any previous or subsequent Example, wherein the processor-executable instructions to determine whether the second client device has access to the application associated with the collaborative session further cause the one or more processors to: Determine that the second client device does not have access the application associated with the collaborative session; and transmit, to the second client device, a prompt to access the application associated with the collaborative session.

Example 19 is the non-transitory computer-readable medium of any previous or subsequent Example, wherein the processor is configured to execute further processor-executable instructions stored in the non-transitory computer-readable medium to: determine a permission level associated with the second client device; and grant access to the collaborative session for the second client device based on the permission level.

Example 20 is the non-transitory computer-readable medium of any previous or subsequent Example, wherein the processor is configured to execute further processor-executable instructions stored in the non-transitory computer-readable medium to: responsive to the second client device accessing the collaborative session, generate a notification of the second client device within the collaborative session.

That which is claimed is:

1. A system comprising:
a non-transitory computer-readable medium;
a communications interface; and
a processor communicatively coupled to the non-transitory computer-readable medium and the communications interface, the processor configured to execute processor-executable instructions stored in the non-transitory computer-readable medium to:
receive, from a first client device, a request to initiate a collaborative session with a second client device;
determine a status associated with a user of the second client device;
determine, responsive to the status associated with the user of the second client device, identity information for the user; and
transmit, to the second client device, access to the collaborative session.

2. The system of claim 1, wherein the instructions to determine the status associated with the user of the second client device further cause the processor to execute further processor-executable instructions stored in the non-transitory computer-readable medium to:
determine a profile associated with the user; and
determine, based on the profile, the identity information for the user.

3. The system of claim 2, wherein the instructions to determine the status associated with the user of the second client device further cause the processor to execute further processor-executable instructions stored in the non-transitory computer-readable medium to determine that the second client device has access to an application associated with the collaborative session; and
the instructions cause the processor to execute further processor-executable instructions stored in the non-transitory computer-readable medium to transmit, to the second client device, access to the collaborative session.

4. The system of claim 1, wherein the instructions to determine the status associated with the user of the second client device further cause the processor to execute further processor-executable instructions stored in the non-transitory computer-readable medium to:
determine that there is not a profile associated with the user; and
transmit, to the second client device, a contact request for the second client device.

5. The system of claim 4, wherein the processor is configured to execute further processor-executable instructions stored in the non-transitory computer-readable medium to:
receive, from the second client device, the identity information for the user responsive to the contact request; and
transmit, to the second client device based on the identity information, access to the collaborative session.

6. The system of claim 1, wherein:
the processor is configured to execute further processor-executable instructions stored in the non-transitory computer-readable medium to establish a virtual meeting having a plurality of participants, wherein the plurality of participants comprises the first client device and the second client device; and
the instructions to receive, from the first client device, the request to initiate the collaborative session with the second client device cause the processor to execute further processor-executable instructions stored in the non-transitory computer-readable medium to:
receive, from the first client device, a request to share collaborative content with the plurality of participants during the virtual meeting; and
share the collaborative content with the plurality of participants during the virtual meeting.

7. A method comprising:
receiving, from a first client device, a request to initiate a collaborative session with a second client device;
determining, by a video conference provider, a status associated with a user of the second client device;
determining, by the video conference provider, identity information for the user responsive to the status associated with the user of the second client device; and
transmitting, by the video conference provider, access to the collaborative session to the second client device.

8. The method of claim 7, wherein determining the status associated with the user of the second client device further comprises:
determining, by the video conference provider, a profile associated with the user;
determining, based on the profile, the identity information for the user;
determining, by the video conference provider, that the second client device has access to an application associated with the collaborative session; and
transmitting, by the video conference provider, access to the collaborative session.

9. The method of claim 7, wherein determining the status associated with the user of the second client device comprises:
determining, by the video conference provider, a lack of a profile associated with the user; and
transmitting, by the video conference provider, a contact request based on the lack of the profile associated with the user.

10. The method of claim 7, wherein determining the status associated with the user of the second client device further comprises determining, by the video conference provider, that the second client device does not have access to an application associated with the collaborative session; and
the method comprises:
transmitting, to the second client device, a prompt to access the application to the second client device.

11. The method of claim 10, wherein the method further comprises:
receiving, from the second client device, a notification that the second client device accepted the prompt to access the application; and
transmitting, responsive to the notification, access to the collaborative session.

12. The method of claim 7, wherein the method further comprises:
determining, by the video conference provider, a permission level associated with the second client device for the collaborative session; and
granting, by the video conference provide, the second client device access to the collaborative session based on the permission level.

13. The method of claim 7, the method further comprising:
establishing, by a video conference provider, a chat channel comprising two or more participants, wherein the two or more participants comprise the first client device and the second client device; and
wherein receiving, from the first client device, the request to access the collaborative session further comprises sharing collaborative content within the chat channel.

14. The method of claim 7, wherein the collaborative session is hosted by an application, and wherein the method further comprises:
determining, by the video conference provider, that the second client device has accessed the collaborative session via the application; and
providing a notification in the application that the second client device has accessed the collaborative session.

15. A non-transitory computer-readable medium comprising processor-executable instructions configured to cause one or more processors to:
receive, from a first client device, a request to initiate a collaborative session with a second client device;
determine a status associated with a user of the second client device;
determine, responsive to the status associated with the user of the second client device, identity information for the user; and
transmit, to the second client device, access to the collaborative session.

16. The non-transitory computer-readable medium of claim 15, wherein the processor-executable instructions to determine the status of the second client device further cause the one or more processors to:
determine whether there is a profile associated with the user; and
determine whether the second client device has access to an application associated with the collaborative session.

17. The non-transitory computer-readable medium of claim 16, wherein the processor-executable instructions to determine whether there is the profile associated with the user further cause the one or more processors to:
determine the profile associated with the user; and
determine, based on the profile associated with the user, the identity information for the user.

18. The non-transitory computer-readable medium of claim 16, wherein the processor-executable instructions to determine whether the second client device has access to the application associated with the collaborative session further cause the one or more processors to:
determine that the second client device does not have access the application associated with the collaborative session; and
transmit, to the second client device, a prompt to access the application associated with the collaborative session.

19. The non-transitory computer-readable medium of claim 15, wherein the processor is configured to execute further processor-executable instructions stored in the non-transitory computer-readable medium to:
determine a permission level associated with the second client device; and
grant access to the collaborative session for the second client device based on the permission level.

20. The non-transitory computer-readable medium of claim 15, wherein the processor is configured to execute further processor-executable instructions stored in the non-transitory computer-readable medium to:
responsive to the second client device accessing the collaborative session, generate a notification of the second client device within the collaborative session.
